(19) United States
(12) Patent Application Publication
(10) Pub. No.: US 2013/0255439 A1
(43) Pub. Date: Oct. 3, 2013

(54) ARRANGEMENT OF AN ADD-ON MODULE AND OF A BASIC TRANSMISSION AND ASSEMBLY METHOD

(71) Applicant: ZF FRIEDRICHSHAFEN AG, Friedrichshafen (DE)

(72) Inventor: Giuseppe MURO, Friedrichshafen (DE)

(73) Assignee: ZF Friedrichshafen AG, Friedrichshafen (DE)

(21) Appl. No.: 13/850,505

(22) Filed: Mar. 26, 2013

(30) Foreign Application Priority Data
Apr. 3, 2012 (DE) 10 2012 205 441.3

(51) Int. Cl. F16H 37/06

(52) U.S. Cl. CPC F16H 37/065
USPC 74/661; 29/893.1

(57) ABSTRACT

A coaxial arrangement of an add-on module having a main axis and a basic transmission having a main axis. The add-on module comprises a drive element that is arranged coaxially with the main axis. The basic transmission has an oil pump is driven by the drive element of the add-on module, via a spur gear stage, and the spur gear stage comprises a first spur gear arranged coaxially with the main axis and a second spur gear arranged offset relative to the main axis. A method for assembling the add-on module with the basic transmission, in which the drive element and the first spur gear can be coupled with one another by a plug-in connection, is also disclosed. During the assembly process, the first spur gear is first coupled, in advance, to the basic transmission and then brought into meshing engagement with the second spur gear.

This application claims priority from German patent application serial no. 10 2012 205 441.3 filed Apr. 3, 2012.

### FIELD OF THE INVENTION

The invention concerns a coaxial arrangement of an add-on module having a main axis and a basic transmission having a main axis. The invention also concerns a method for assembling the add-on module and the basic.

### BACKGROUND OF THE INVENTION

In a known mass-produced transmission by the present applicant a hybrid module is connected to a basic transmission, the hybrid transmission comprising an electric machine and a planetary gear system and functioning as a common gear unit for an internal combustion engine and electric drive system. The basic transmission, which is arranged coaxially with the main axis of the hybrid module, comprises a central oil pump with an offset axis which is driven by the hybrid module by way of a spur gear stage having a first and a second spur gear. In this case the first spur gear, which is coaxial with the main axis, is pre-fitted onto a drive element of the hybrid module while the second spur gear, which is arranged offset relative to the main axis, is fixed to the basic transmission, i.e. attached to the drive input shaft of the oil pump. During the process of assembling the hybrid module and the basic transmission, which takes place along the direction of the main axis, the teeth of the first, coaxial spur gear have to be brought into engagement with the teeth of the second, axially offset spur gear. This can be problematic if a tooth-on-tooth position occurs and the two spur gears do not mesh immediately. The same problem can also occur during the assembly of a known converter module with the basic transmission, since, in this case as well, the first spur gear is pre-fitted on the converter side.

### SUMMARY OF THE INVENTION

The purpose of the present invention is to provide an arrangement of the type mentioned to begin with, which is easy to assemble, and to propose a method that enables easy assembly of the add-on module onto the basic transmission.

According to the invention, it is provided that the drive element of the add-on module and the first spur gear can be coupled to one another by means of a plug-in connection. This has the advantage that the first spur gear and the second spur gear, which form the spur gear stage that drives the oil pump, are positioned and can be brought into meshing engagement with one another before assembly onto the basic transmission. During the assembly of the add-on module and the basic transmission, the two spur gears therefore no longer have to be aligned for exact meshing, but rather, only the plug-in connection between the drive element of an add-on module and the first spur gear has to be formed. The drive element is understood to mean a drive output element of the add-on module which drives the basic transmission or the spur gear stage of the oil pump. The plugging together of the plug-in connection (alignment) is not critical. Damaging of the spur gears of the spur gear stage during assembly is excluded.

In a preferred embodiment, the plug-in connection is formed by drive-teeth, i.e. the drive element of the add-on module has a set of outer drive-teeth and the spur gear has a set of inner drive-teeth, which are brought together with the outer drive-teeth in the axial direction. These two parts of the drive-teeth array can be aligned without difficulty.

According to a further preferred embodiment, the first spur gear is accommodated in a housing component of the basic transmission.

According to another preferred embodiment, between the first spur gear and the housing component is positioned a bearing washer, which fulfills the functions on the one hand of a bearing disk and on the other hand of additional centering means for the first spur gear relative to the basic transmission, thus enabling the subsequent alignment and insertion of the plug-in connection and thereby facilitating assembly.

According to a further preferred embodiment the bearing washer has, on its face directed toward the first spur gear, lubrication grooves that improve the lubrication between the flat faces of the first spur gear and the bearing washer itself. This in effect constitutes an axially acting slide bearing.

In another preferred embodiment, on its face directed toward the housing component, the bearing washer has holding studs which serve to attach the bearing washer to the housing component. This makes it possible to fix the bearing washer in the housing component in advance, so that it serves as a stop for the first spur gear during assembly.

According to a further preferred embodiment the bearing washer has a centering collar with a lead-in bevel. This facilitates and assists the fitting and positioning of the first spur gear in the housing component of the basic transmission. The first spur gear is thereby centered in the basic transmission, i.e. aligned coaxially with the main axis. The subsequent insertion of the plug-in connection is thereby facilitated.

According to another preferred embodiment, the add-on module is in the form of a converter module comprising a hydrodynamic converter as a starting aid for the basic transmission. The converter module and the basic transmission are produced beforehand as separate structural units, which are then assembled together to form a complete assembly. In this case the first spur gear is no longer pre-fitted onto the converter module, but is already arranged in the basic transmission before assembly and is brought into meshing engagement with the second spur gear.

In another preferred embodiment the add-on module is in the form of a hybrid module comprising an electric machine and a planetary gear system arranged between the electric machine and the basic transmission. The planetary gear system transmits the torque and power between the internal combustion engine and/or electric machine on the one hand, and the basic transmission on the other hand.

According to a further preferred embodiment, around its periphery the hybrid module has a sealing element, which is preferably in the form of an O-ring and seals the hybrid module against a flange of the basic transmission. The fitting of the O-ring is part of the assembly process.

According to another preferred embodiment, the drive element of the hybrid module is in the form of the planetary carrier or web of the planetary gear system. Thus, by way of its planetary carrier the planetary gear system drives the oil pump in the basic transmission.

According to another aspect of the invention, in a method for assembling the add-on module and the basic transmission to one another it is provided that in a first process step the first spur gear is positioned in the basic transmission and brought into meshing engagement with the second spur gear. This eliminates the problematic alignment and meshing of the two spur gears during assembly. Thus, no longer can the spur gears be damaged during the assembly process, since the two spur gears of the spur gear stage are already mutually engaged before the add-on module and the basic transmission are assembled together.

In another preferred method variant, before the first spur gear is positioned in the basic transmission, a bearing washer is set into a housing component of the basic transmission, which enables the first spur gear to be centered. At the same time the spur gear arranged in the basic transmission has a contact surface that serves as a stop during the subsequent formation of the plug-in connection.

According to a further preferred method variant, in a second process step the add-on module or hybrid module is brought in along the direction of the main axis and at the same time the drive element or planetary carrier is fitted onto the first spur gear and a plug-in connection is formed. If a tooth-on-tooth position of the drive-teeth occurs during the fitting process, it can be eliminated by a slight twisting movement.

In a further preferred method variant, in a third process step, i.e. during the continued assembly movement in the axial direction, the sealing element is fitted, i.e. the flange of the basic transmission is pushed over the O-ring arranged in the hybrid module. At this stage the plug-in connection has already been formed, i.e. the drive-teeth are in mutual engagement. Thus, it is important that the plug-in connection is formed first and the O-ring seal is fitted subsequently. This makes it possible when aligning the plug-in connection, to see whether there is initially a tooth-on-tooth position and, if there is, to correct it immediately.

### BRIEF DESCRIPTION OF THE DRAWINGS

An example embodiment of the invention is illustrated in the drawings and will be described in more detail below, so that further features and/or advantages can emerge from the description and/or the drawings, which show:

FIGS. 1A, 1B: A hybrid module and a basic transmission of the prior art, before assembly,

FIGS. 2A, 2B: A basic transmission before and after assembly according to the invention,

FIG. 3: An axial section of the hybrid module during assembly,

FIG. 4: An enlarged view of a plug-in connection between the first spur gear and the planetary carrier,

FIGS. 5A, 5B: Two views of a bearing washer, and

FIG. 6: A converter module of the prior art.

### DETAILED DESCRIPTION OF THE PREFERRED EMBODIMENTS

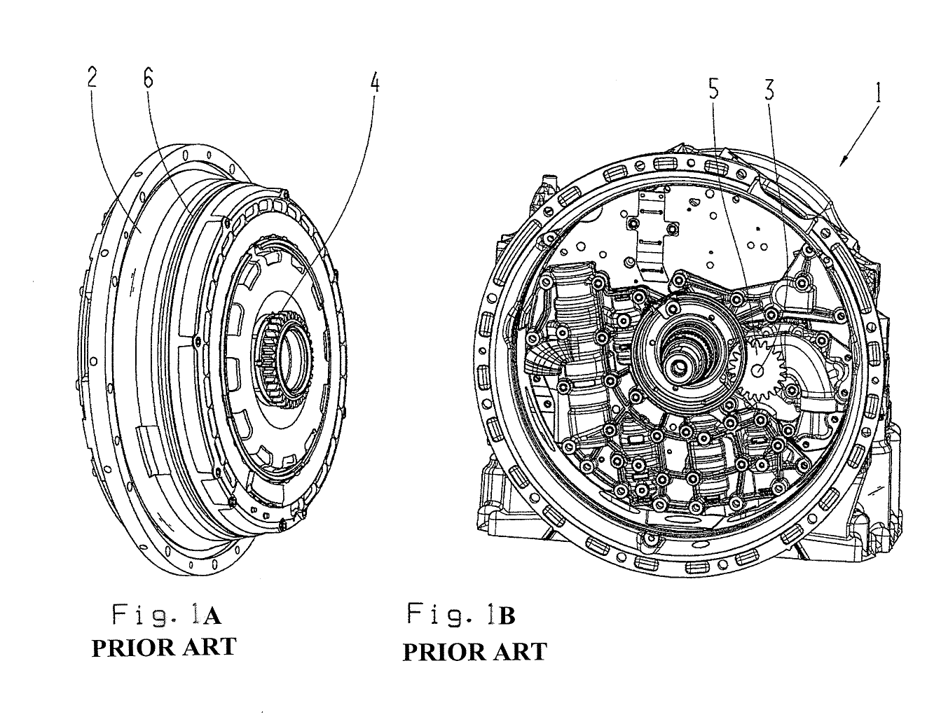

FIGS. 1A, 1B show a basic transmission 1 and a hybrid module 2 of the prior art, as preassembled structural units before their assembly to one another. The basic transmission 1 can be in the form of an automatic or manually shifted variable-speed transmission and can be built into a drive-train of a motor vehicle. The basic transmission 1 has on oil pump (not visible), which can be driven by way of an axially offset pump shaft 3. The hybrid module 2, generally also referred to as the add-on module 2, comprises an electric machine (not shown) that can be connected between an internal combustion engine (not shown) of the motor vehicle and the basic transmission 1. Onto the hybrid module 2 is pre-fitted a first spur gear 4, while a second spur gear 5 is fixed onto the basic transmission 1, namely on its pump shaft 3. To assemble the hybrid module 2 and the basic transmission 1 together, the two structural units 1, 2 are aligned coaxially and brought together along the axial direction. During this the first spur gear 4 has to be aligned so that the two sets of drive-teeth engage in one another, i.e. so that a tooth of the first spur gear 4 engages in a tooth gap of the second spur gear 5. In addition the hybrid module 2 has a sealing element 6 in the form of an O-ring, which is fitted against a flange of the basic transmission when the two units 1, 2 are assembled together. During the meshing of the two spur gears 4, 5, which in operation form a spur gear stage for driving the oil pump, problems can arise if a tooth-on-tooth position occurs.

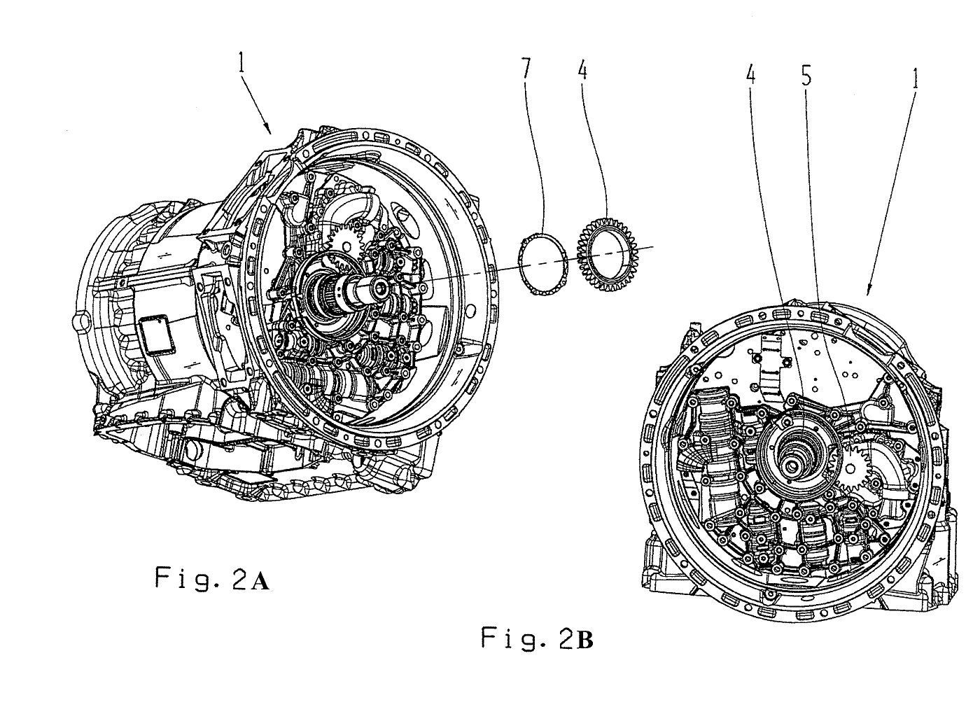

FIGS. 2A, 2B show an assembly process of the first spur gear 4 according to the invention, wherein FIG. 2A the basic transmission 1 is shown before the first spur gear 4 has been fitted and FIG. 2B it is shown after the first spur gear 4 has been fitted. In FIGS. 1A, 1B and FIGS. 2A, 2B, the same indexes are used for the same components. The representation of the basic transmission 1 of FIG. 2B shows that the first spur gear 4 is positioned coaxially in the basic transmission 1 and will enter into meshing engagement with the second spur gear 5. The positioning of the first spur gear 4 in the basic transmission 1 and its alignment with the teeth of the second spur gear 5 constitute the first process step of the assembly process. In addition to and before the positioning of the first spur gear 4, a bearing washer 7 is fitted between the first spur gear 4 and the basic transmission 1.

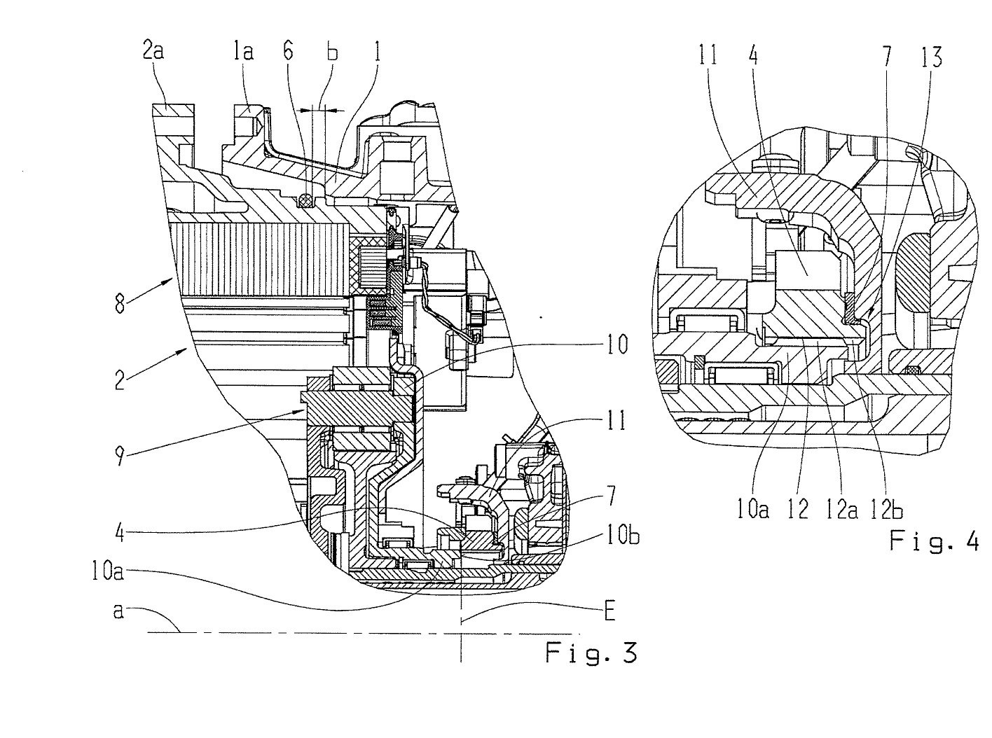

FIG. 3 shows an axial section through the hybrid module 2 and through the partially represented basic transmission 1. The hybrid module 2 and the basic transmission 1 have a common main axis a and are brought together along the direction of the main axis a. The hybrid module 2 has an all-round flange 2a and the basic transmission 1 has an all-round flange 1a, which will be connected to the flange 2a. In the area of the two flanges 1a, 2a is arranged the sealing element 6 in the form of an O-ring. FIG. 3 shows the hybrid module 2 and the basic transmission 1 in an intermediate position, i.e. when the assembly process has not yet been completed. The hybrid module 2 comprises an electric machine 8 and a planetary gear system 9, which transmits the power from the electric machine 8 and/or from an internal combustion engine (not shown) of the motor vehicle. The planetary gear system 9 has on its output side a planetary carrier 10, also referred to more generally as the drive element, which comprises a section in the form of a neck 10a with an end face 10b. In the basic transmission 1 there is a recess-like housing component 11 into which the bearing washer 7 is fitted (see also FIG. 2A.). Furthermore, the first spur gear 4 is positioned coaxially with the main axis a and is centered by means of the bearing washer 7. The basic transmission 1 and the hybrid module 2 are in an assembly position which is made clear by a radial plane E that extends flush with the end face 10b of the neck section 10a. The neck 10a of the planetary carrier 10, which is to be connected with the first spur gear 4 by means of drive-teeth (not indexed), is still outside of the engagement zone but immediately before the mutual engagement of the two sets of drive-teeth. On the other side the O-ring 6 is still free and a distance b away from an edge of the housing flange 1a. If, when the basic transmission 1 and the hybrid module 2 are moved farther toward one another, i.e. beyond the plane E, a blockage should occur because of a tooth-on-tooth position, then this can be corrected by a slight twisting movement so that the assembling process can continue until the two drive-teeth sets of the neck 10a and the first spur gear 4, respectively, are fully overlapped. During this assembly movement the bearing washer 7 acts as an axial stop.

FIG. 4 shows an enlarged representation of the connection between the first spur gear 4 and the neck 10a of the planetary carrier 10. The connection is in the form of a plug-in joint 12 by way of drive-teeth, with outer drive-teeth 12a on the neck 10a and inner drive-teeth 12b in the bore of the first spur gear 4. In the position shown the assembly process is complete inasmuch as the drive-teeth 12 are fully engaged, i.e. they overlap over the full axial width. An arrow 13 indicates a centering zone which comprises, on the one hand, a bore in the housing component 11 and, on the other hand, a centering shoulder on the bearing washer 7 and a centering collar on the first spur gear 4. This enables the first spur gear 4 to be aligned coaxially with the main axis a during assembly, and thus to be prepared for the formation of the plug-in connection 12.

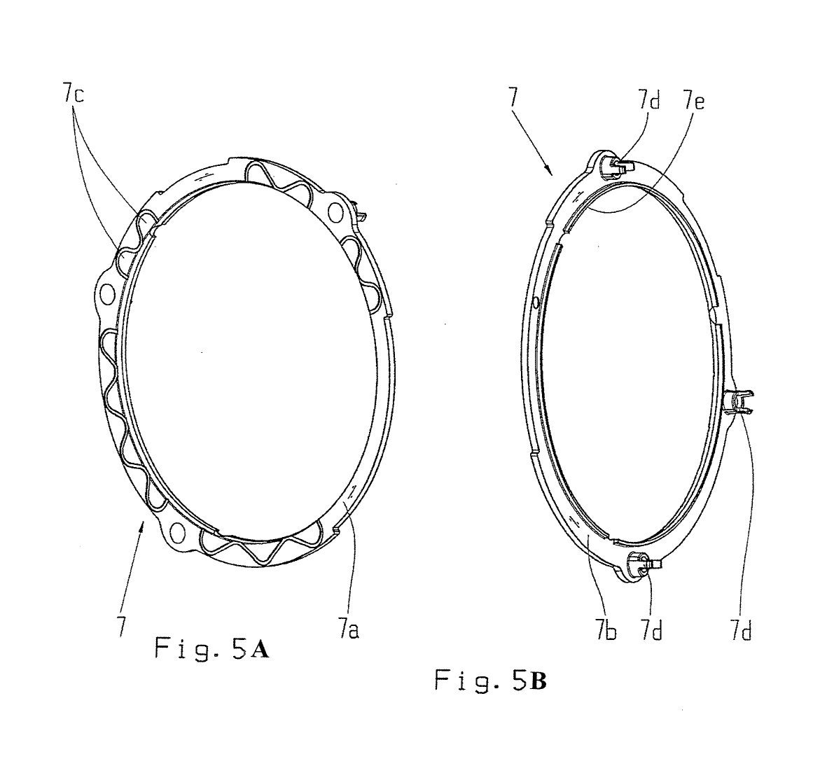

FIGS. 5A, 5B show two views of the bearing washer 7, such that the view of

FIG. 5A shows a first face 7a in which lubrication grooves 7c are formed. This first face 7a with the lubrication grooves 7c rests against the flat surface of the first spur gear 4. The view of the bearing washer 7 of FIG. 5B shows a second face 7b on which a number of holding studs 7d are distributed around the circumference, which serve to fix the bearing washer 7 in the housing component 11. Thus, the bearing washer 7 can be fixed in the housing component 11. Moreover, the bearing washer 7 has a centering collar 7e which—as can be seen in FIG. 4—serves to center the bearing washer 7 relative to a corresponding bore in the housing component 11. Accordingly, the bearing washer 7 has more than one function: on the one hand it serves as a stop and a bearing washer, and on the other hand as a centering aid for the first spur gear 4 in the housing component 11.

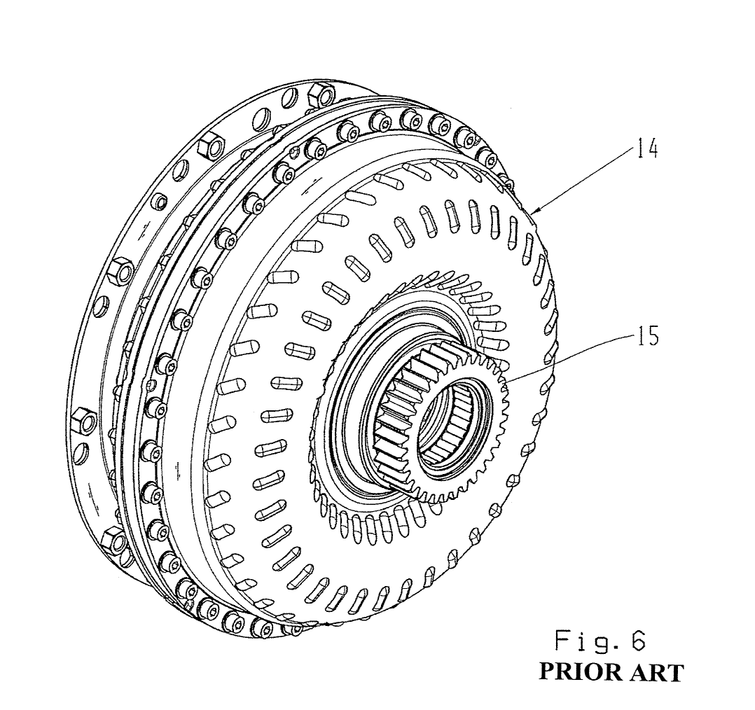

FIG. 6 shows a known, so-termed converter module 14, in general also referred to as an add-on module. As is known from the prior art, the converter module 14 comprises a hydrodynamic converter that can be connected upstream from a basic transmission as a starting aid. In this case a first spur gear 15 is pre-fitted on the output side of the converter module 14 or its drive element, for example by welding, and in combination with a second spur gear arranged on the basic transmission this forms a spur gear stage for driving an oil pump. The known assembly process takes place analogously to that described for the known hybrid module shown in FIGS. 1A, 1B. Accordingly, during assembly with the basic transmission the circumferential position of the first spur gear 15 has to be aligned relative to the second spur gear so as to enable the teeth to mesh. To eliminate the associated difficulties, according to the invention it is provided that in the case of this known converter 14 the first spur gear 15 is not pre-fitted on the converter module 14, but before assembling the two structural units together it is positioned on the basic transmission and brought into meshing engagement with the second spur gear. Thereafter the drive element of the converter module 14 is connected by a plug-in connection to the first spur gear, i.e. in a manner analogous to the above example embodiment illustrated in FIGS. 2A to 5B. This gives the same advantages as described above for the hybrid module 2.

### Indexes

1 Basic transmission

1a Flange

2 Hybrid module

2a Flange

3 Pump shaft

4 First spur gear

5 Second spur gear

6 Sealing element (O-ring)

7 Bearing washer

7a First face

7b Second face

7c Lubrication grooves

7d Holding studs

7e Centering collar

8 Electric machine

9 Planetary gear system

10 Planetary carrier

10a Neck

10b End face

11 Housing component

12 Plug-in connection

12a Outer drive-teeth

12b Inner drive-teeth

13 Centering zone

14 Converter module

15 First spur gear

a Main axis

b Distance

E Radial plane

1-15. (canceled)

16. A coaxial arrangement of an add-on module (2, 14), having a main axis (a), and a basic transmission (1) coaxially aligned along the main axis (a),
wherein the add-on module (2, 14) comprises a drive element (10) arranged coaxially with the main axis (a),
the basic transmission (1) comprises an oil pump that is drivable by the drive element (10) of the add-on module (2), via a spur gear stage, and the spur gear stage comprises a first spur gear (4) arranged coaxially along the main axis (a) and a second spur gear (5) arranged offset relative to the main axis (a), and
the drive element (10, 10a) and the first spur gear (4) are coupled to one another by a plug-in connection (12).

17. The arrangement according to claim 16, wherein the plug-in connection (12) comprises outer drive-teeth (12a) on the drive element (10a) and inner drive-teeth (12b) on the first spur gear (4).

18. The arrangement according to claim 16, wherein the first spur gear (4) is accommodated in a housing component (11) of the basic transmission (1).

19. The arrangement according to claim 18, wherein a bearing washer (7) is arranged between the housing component (11) and the first spur gear (4).

20. The arrangement according to claim 19, wherein the bearing washer (7) has a first face (7a) with lubrication grooves (7c), and the first face is directed toward the first spur gear (4).

21. The arrangement according to claim 19, wherein the bearing washer (7) has a second face (7b) with holding studs (7d), and the second face is directed toward the housing component (11).

22. The arrangement according to claim 19, wherein the bearing washer (7) has a centering collar (7e) with a lead-in bevel.

23. The arrangement according to claim 16, wherein the add-on module is a converter module (14).

24. The arrangement according to claim 16, wherein the add-on module is a hybrid module (2) and comprises an electric machine (8).

25. The arrangement according to claim 24, wherein a sealing element (6) is arranged between the hybrid module (2) and the basic transmission (1).

26. The arrangement according to claim 24, wherein the drive element is a planetary carrier (10) of a planetary gear system (9).

27. A method of coaxially assembling an add-on module (2, 14), having a main axis (a), and a basic transmission (1) coaxially aligned along the main axis (a), wherein the add-on module (2, 14) comprises a drive element (10) arranged coaxially with the main axis (a), the basic transmission (1) comprises an oil pump that is drivable by the drive element (10) of the add-on module (2), via a spur gear stage, and the spur gear stage comprises a first spur gear (4) arranged coaxially along the main axis (a) and a second spur gear (5) arranged offset relative to the main axis (a), the drive element (10, 10a) and the first spur gear (4) are coupled to one another by a plug-in connection (12), and the method comprising the step of:
positioning the first spur gear (4) in the basic transmission (1); and
bringing the first spur gear stage into meshing engagement with the second spur gear (5).

28. The method according to claim 27, further comprising the step of centering the first spur gear (4), relative to the housing component (11) in the basic transmission (1), with a bearing washer (7).

29. The method according to claim 27, further comprising the step of assembling the add-on module (2) and the basic transmission (1) together along the main axis (a) and during this assembly, forming the plug-in connection (12) by inserting the drive element (10a) into the first spur gear (4).

30. The method according to claim 29, further comprising the step of fitting a sealing element (6) between the add-on module (2) and the basic transmission (1).

31. A coaxial arrangement of an add-on module (2, 14) and a basic transmission (1) along a main axis (a),
the add-on module (2, 14) comprising a drive element (10) that is coaxial with the main axis (a),
the basic transmission (1) comprising an oil pump that is driven by the drive element (10) of the add-on module (2), via a spur gear stage, and
the spur gear stage comprising a first spur gear (4) that is arranged coaxially with the main axis (a) and a second spur gear (5) that is arranged offset relative to the main axis (a), and the drive element (10, 10a) and the first spur gear (4) are coupled to one another by a plug-in connection (12).
